(19) United States
(12) Patent Application Publication
(10) Pub. No.: US 2013/0054316 A1
(43) Pub. Date: Feb. 28, 2013

(54) MANAGING PRESENTATION OF COMMERCIAL COMMUNICATIONS INCLUDING ELECTRONIC MAIL AND ADVERTISEMENTS

(71) Applicants: Chad Estes, Woodinville, WA (US); Michael Kunz, Seattle, WA (US); Walter Harp, Mercer Island, WA (US); Wook Chung, Sunnyvale, CA (US)

(72) Inventors: Chad Estes, Woodinville, WA (US); Michael Kunz, Seattle, WA (US); Walter Harp, Mercer Island, WA (US); Wook Chung, Sunnyvale, CA (US)

(73) Assignee: MICROSOFT CORPORATION, Redmond, WA (US)

(21) Appl. No.: 13/215,219

(22) Filed: Aug. 22, 2011

(51) Int. Cl. G06Q 30/00

(52) U.S. Cl. 705/14.4

(57) ABSTRACT

Commercial communications, such as advertisements or promotions, are collected from multiple channels and presented in a consistent format. Using metadata associated with or derived from such communications, they can be searched, sorted, displayed and otherwise managed in a way that allows them to be persistent instead of ephemeral.

### BACKGROUND

Computer users receive communications through a variety of channels, including but not limited to electronic mail, advertisements on web pages, instant messaging, social media and the like. Some of these communications are primarily commercial in nature, such as a form of advertisement or promotion intended to invite the recipient to evaluate or purchase a good or service.

Because of the variety of channels through which commercial communications are received, the presentation of such communications to a user is inconsistent and distracting. A typical user can find such communications a nuisance.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Commercial communications, such as advertisements or promotions, are collected from multiple channels and presented in a consistent format. Using metadata associated with or derived from such communications, they can be searched, sorted, displayed and otherwise managed in a way that allows them to be persistent instead of ephemeral.

Accordingly, in one aspect, commercial communications from one or more channels are received into memory. Information about the commercial communications is extracted and stored. One or more views of aggregated information about the commercial communications are presented to a user. The user is enabled to interact with the aggregated information about the commercial communications. Commercial communications can be filtered from noncommercial communications from at least one of the one or more channels.

The one or more views can include a calendar view of multiple commercial communications, and/or a map view illustrating a location of a source related to one or more multiple commercial communications. A view of the commercial communications can include grouping and displaying messages by sender, and/or by subject matter, and/or by keyword, and/or by other metadata associated with the messages.

One of the channels can include electronic mail and another of the channels can include advertisements from an advertisement server. Information about advertisements can be stored persistently for a user. Input from a user can be received for rating commercial communications. Such rating information can be stored with the information about the commercial communications.

In the following description, reference is made to the accompanying drawings which form a part hereof, and in which are shown, by way of illustration, specific example implementations of this technique. It is understood that other embodiments may be utilized and structural changes may be made without departing from the scope of the disclosure.

### DESCRIPTION OF THE DRAWINGS

FIG. 1 is a block diagram of an example system for managing commercial communications.

FIG. 2 is an example display of aggregated commercial communications.

FIG. 3 is another example display of aggregated commercial communications.

FIG. 4 is an example calendar view of aggregated commercial communications.

FIG. 5 is a flow chart describing operation of an example system.

FIG. 6 is a flow chart describing an example of user interaction with such a system.

FIG. 7 is a block diagram of an example computing device in which such a system can be implemented.

### DETAILED DESCRIPTION

The following section provides an example operating environment in which such a system can be implemented.

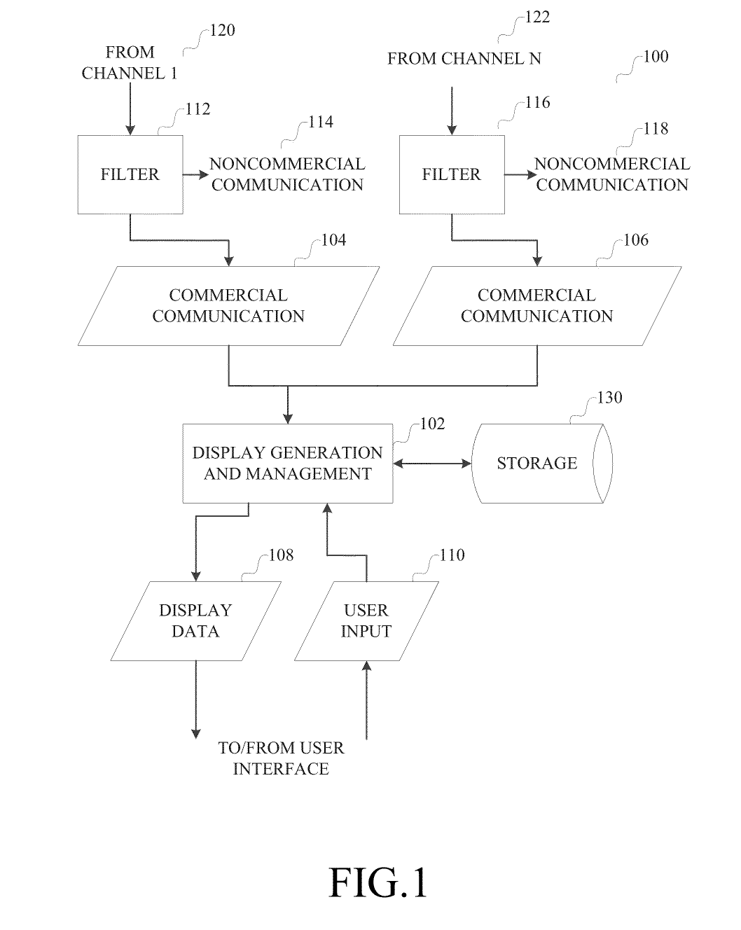

Referring to FIG. 1, an application 100 includes a display generator 102 for commercial communications. This display generator receives commercial communications 104, 106 from multiple channels and collects and presents them in an aggregated view, as shown by display data 108. The display data 108 is presented to the user through a user interface on some display device (not shown). Through the user interface, user inputs 110 can be received and processed by the display generator 102 to allow the user to manipulate the views of the commercial communications and/or manage the commercial communications.

As an example, the display generator 102 may be part of an electronic mail (email) system accessible by users through an internet browser (forming part of the user interface). The email system may present emails (some of which may include commercial communications), and also may include areas of the display that include paid advertisements (another form of commercial communication).

At least one of the channels 120 for communication includes a filter 112 that separates commercial messages 104 from other messages 114. In this example, the email system has a filter 112 that performs this function. It is possible for multiple communication channels 122 to have such a filter, such as shown at 116, which separates commercial messages 106 from other messages 118. However, in the case where the second channel is provided by an advertisement server, such a filter is not used.

The filtering operation performed by filters 112 and 116 can be any of a variety of possible ways of detecting commercial communications. A user can flag a sender as being a source of commercial communications. In such a case, the filter checks the sender of each communication against a list of known sources of commercial communications. A sender can tag a communication in a way that indicates it is a commercial communication. In such a case, the filter checks the tag of each message. Other filters could incorporate keywords or patterns of keywords, such as “offer expires” or the like. To the extent that the commercial communications are structured, or semi-structured, the information provided by such structure can be used by a filter.

The display generator 102 produces the display data 108 by aggregating the commercial communications from the different channels into a consistent view. By a consistent view, it is intended to mean that the communications from the different channels are presented in generally the same way, regardless of the channel from which they are received. It should be understood that the display could indicate in some way the source from which the communication was received, the content of the communications are generally presented in the same way.

In addition to the presentation, display generator 102 can manage and store information about the communications in storage 130. The storage 130 can include metadata about the communications, and could include a copy of the communications or information that would enable the communication to be retrieved from another source. Various metadata about the communication can include a name of the sender, sender location, sender contact information, date of receipt of the communication, subject matter, offer expiration date, and the like. Commercial communications thus can be stored (and deleted), either automatically or under direction from the user.

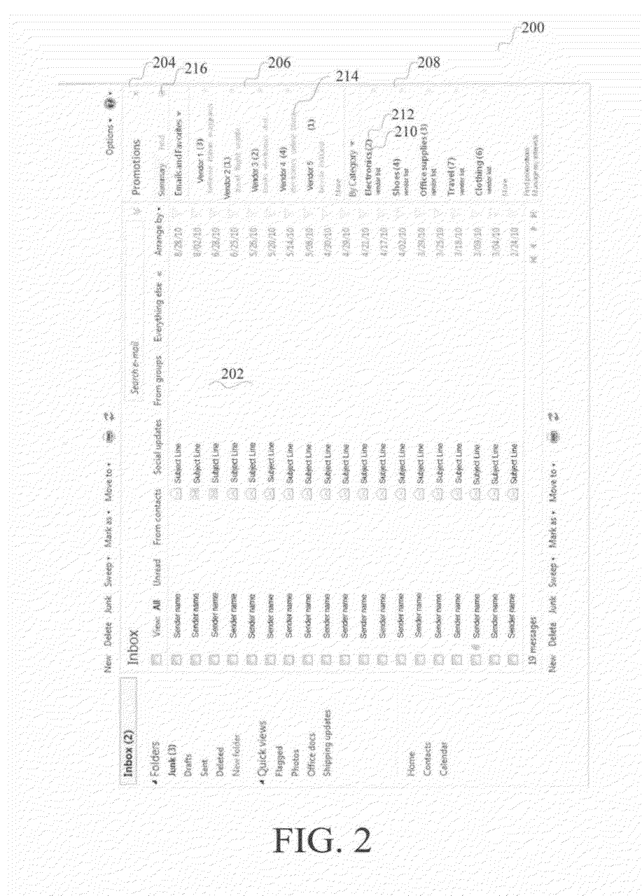

Given this context, an example implementation of such a system will be described in more detail below in connection with FIGS. 2-4.

In FIG. 2, an example display is shown, where the communications arrive in the form of email and advertisements from an ad server. The display 200 includes a mail message section 202 and a promotions section 204. The mail message section displays emails that have been received, which can be in any format typical for an email system. The promotions section 204 includes a display of aggregated commercial messages from the email and ad server (or optionally other sources).

In this example, the relative positions of the mail message section and promotions section are merely illustrative. The two sections can have a wide variety of relative positions, and can be displayed at different times or can be overlapping. It should be understood that such a display is merely an example. There are other ways in which the commercial messages could be displayed consistently.

In the example promotions section display, communications can be grouped, and groups can be displayed, such as shown at 206 and 208. Group 206 shows messages grouped by sender. Group 208 shows messages grouped by category. A group can be created using any of the metadata that has been captured for the commercial communications. In this example, each group is displayed using a word 210 indicative of the group, a number 212 of the number of messages in the group and keywords 214 extracted from the messages.

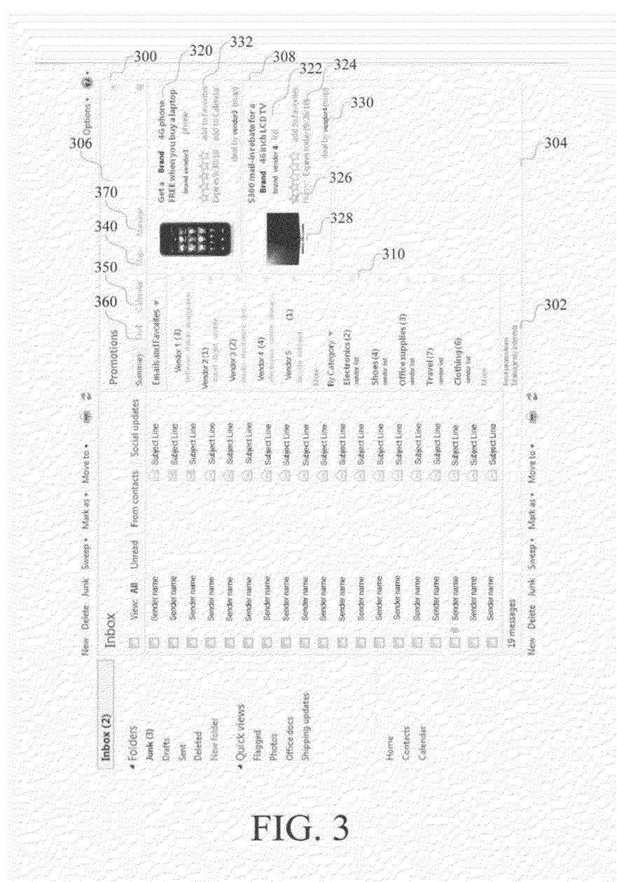

In FIG. 2, a summary view is shown. Other views and more information can be shown by expanding the view, which the user activates by selecting an expansion button 216. In response to such a user action, a more detailed display is presented, as shown in FIG. 3.

In FIG. 3, the promotions section 300 includes the summary section 302 (as shown in FIG. 2), and a detail section 304. Also, other tabs 306 are shown, which allow other views of the commercial communications to be seen. In the detail section, individual messages 308 are shown from a selected category (in this example, electronics 310). In response to a user selecting a category, information about the messages in that category are obtained from storage, and presented in the detail section 304. Examples of information that can be presented include, but are not limited to, an image 328, a subject line 320, keywords 322, expiration date 324, and rating 326, source 330.

The rating 326 can be an interactive part of the interface. In other words, the system can present the rating in a manner that would allow a user to provide input about the rating. For example, as shown in FIG. 3, the rating 326 is displayed as sequence of stars. If the rating is 3 out of 5, then three of the stars could be colored and the other two could be blank. If the user wants to input a rating or change a rating, the user selects a star. In response to the user selecting a star, a rating corresponding to that star is stored in the database and the presentation of the rating in the display is set according to that rating.

Similarly, the system can maintain a list of favorites of the commercial communications. In response to the user selecting a message as a favorite (for example, by selecting an “add to favorites” button 332), information about the message can be stored in a favorites list.

If the message has a source (such as shown at 330), the user can select to see a map with this source on it. In response to such a selection, a map tab 340 is displayed. On the map tap, a map can be displayed illustrating the location of the vendors associated with one or more selected messages.

If the message has a date (such as shown at 324), the user can select to see a calendar with this (and optionally other) communications in a calendar view. In response to such a selection, a calendar tab 350 is displayed (which is described in more detail below).

Also in this example, a set of tabs, or, different views, also is provided as indicated at 340, 350, 360 and 370. In addition to the map tab 340 and calendar tab 350, this example also includes a find tab 360 and a manage tab 370, also described in more detail below. It should be understood that these different views are merely illustrative and not limiting of the invention. Other views could be provided, and other mechanisms for activating such views other than tabs can be used.

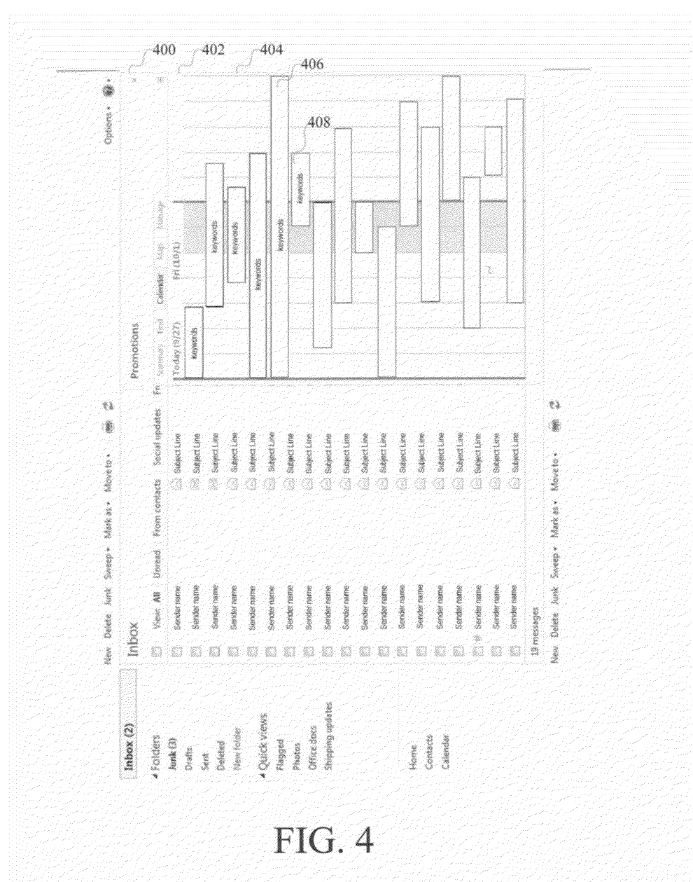

An example calendar view of the commercial communications will now be described in connection with FIG. 4. It should be understood that commercial communications can be displayed in a calendar or other time-based view in a variety of different formats, and the format shown in FIG. 4 is merely an example. This view 400 includes a timeline 402 indicative of the time frame for which messages are being displayed. The timeline in this example is shown in days, but other measures of time can be used. Given one or more messages, a time span for the message is determined. This time span can be calculated, for example, by the difference between the date of the message and any expiration date for the message. A row 404 is selected for a message, and a time bar 406 is placed in that row on the time span covered by the message. Information about the message can be place on the time bar, as shown at 408, to allow the user to distinguish messages from each other. The interface can be such that a user can select one or more of the messages, in response to which the system can change the view, add them to favorites, or perform other actions.

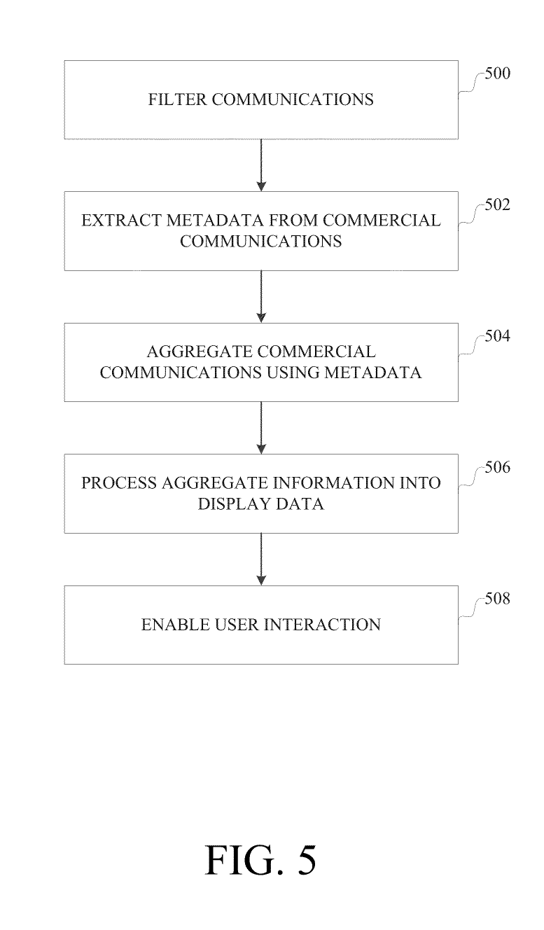

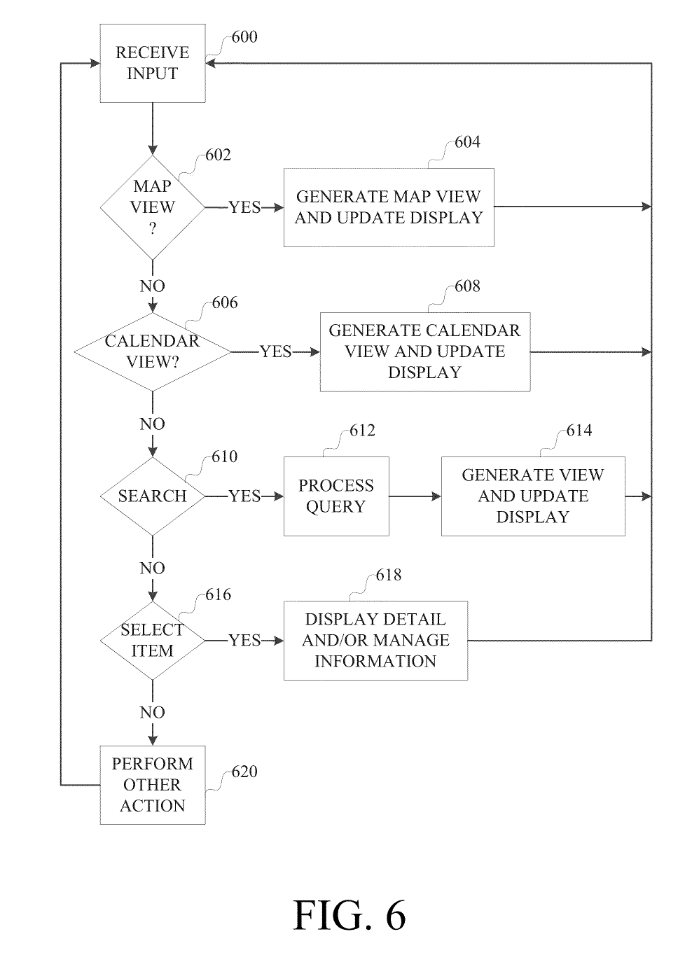

Having now described some example displays and interactions with the system, flow charts describing example operations of such a system will now be described in connection with FIGS. 5 and 6.

In FIG. 5, an example process performed by the system will now be described. Communications that are received are filtered 500 to separate commercial communications from non commercial communications. It is possible that multiple channels are providing commercial communications, and that one or more of those channels are providing only commercial communications. If a channel provides only commercial communications, it need not be filtered. Metadata can be extracted 502 from such communications, such as a name of the sender, sender location, sender contact information, date of receipt of the communication, subject matter, images, keywords, offer expiration date, and the like. Commercial communications are then aggregated 504, with metadata being stored in storage. The aggregated information is processed 506 into display data, and displayed to the user through an appropriate user interface. User interaction with the commercial communication can then be enabled 508.

An example of such user interaction is shown in FIG. 6. The system receives 600 user input through the user interface. If the user input is a selection of a map view, as determined at 602, then a map view is generated and the display is updated 604. If the user input is a selection of a calendar view, as determined at 606, then a calendar view is generated and the display is updated 608. If the user input is a search, as determined at 610, then a query is performed 612. The results of the query are processed into a display, and the display is updated 614. If the user input is a selection of a message, as determined at 616, then information about the messages is displayed 618, and/or other management actions can be taken (such as rating the item, forwarding the item to another user, deleting the item, etc.). After these or other user actions are performed and the display or management data is updated, as indicated at 620, additional inputs can be received, as indicated at 600.

Such a system allows commercial communication to be managed and manipulated by a user in a convenient manner. In addition, information about otherwise ephemeral advertisements can be retained. Such tools make commercial communications more useful to consumers and increase their utilization and impression rates, which is beneficial to advertisers.

Having now described an example implementation, a computing environment in which such a system is designed to operate will now be described. The following description is intended to provide a brief, general description of a suitable computing environment in which this system can be implemented. The system can be implemented with numerous general purpose or special purpose computing hardware configurations. Examples of well known computing devices that may be suitable include, but are not limited to, personal computers, server computers, hand-held or laptop devices (for example, media players, notebook computers, cellular phones, personal data assistants, voice recorders), multiprocessor systems, microprocessor-based systems, set top boxes, game consoles, programmable consumer electronics, network PCs, minicomputers, mainframe computers, distributed computing environments that include any of the above systems or devices, and the like.

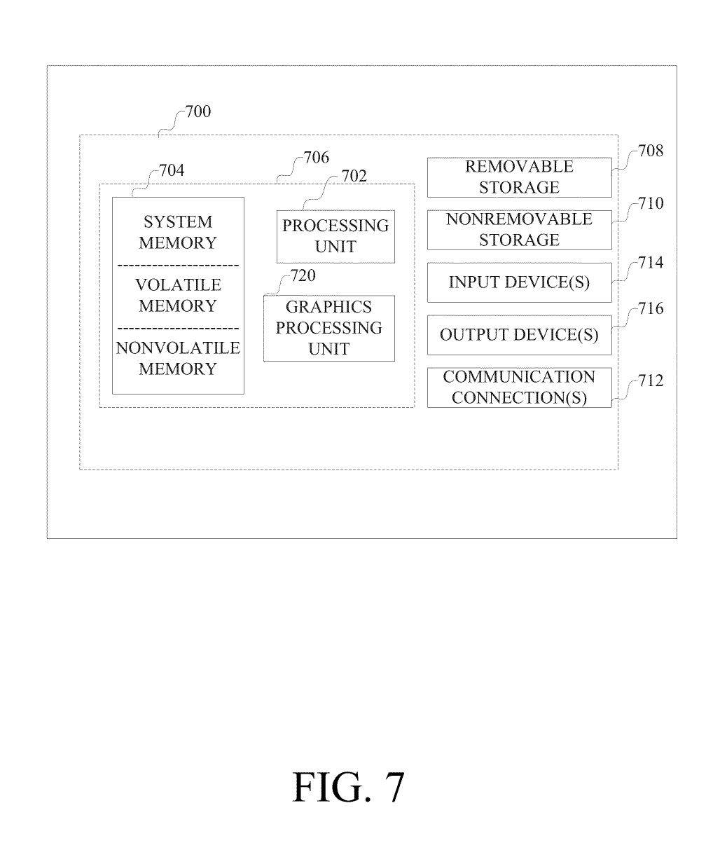

FIG. 7 illustrates an example of a suitable computing system environment. The computing system environment is only one example of a suitable computing environment and is not intended to suggest any limitation as to the scope of use or functionality of such a computing environment. Neither should the computing environment be interpreted as having any dependency or requirement relating to any one or combination of components illustrated in the example operating environment.

With reference to FIG. 7, an example computing environment includes a computing machine, such as computing machine 700. In its most basic configuration, computing machine 700 typically includes at least one processing unit 702 and memory 704. The computing device may include multiple processing units and/or additional co-processing units such as graphics processing unit 720. Depending on the exact configuration and type of computing device, memory 704 may be volatile (such as RAM), non-volatile (such as ROM, flash memory, etc.) or some combination of the two. This most basic configuration is illustrated in FIG. 7 by dashed line 706. Additionally, computing machine 700 may also have additional features/functionality. For example, computing machine 700 may also include additional storage (removable and/or non-removable) including, but not limited to, magnetic or optical disks or tape. Such additional storage is illustrated in FIG. 7 by removable storage 708 and non-removable storage 710. Computer storage media includes volatile and nonvolatile, removable and non-removable media implemented in any method or technology for storage of information such as computer program instructions, data structures, program modules or other data. Memory 704, removable storage 708 and non-removable storage 710 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing machine 700. Any such computer storage media may be part of computing machine 700.

Computing machine 700 may also contain communications connection(s) 712 that allow the device to communicate with other devices. Communications connection(s) 712 is an example of communication media. Communication media typically carries computer program instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media such as acoustic, RF, infrared and other wireless media.

Computing machine 700 may have various input device(s) 714 such as a display, a keyboard, mouse, pen, camera, touch input device, and so on. Output device(s) 716 such as speakers, a printer, and so on may also be included. All of these devices are well known in the art and need not be discussed at length here.

Such a system can be implemented in the general context of software, including computer-executable instructions and/or computer-interpreted instructions, such as program modules, being processed by a computing machine. Generally, program modules include routines, programs, objects, components, data structures, and so on, that, when processed by a processing unit, instruct the processing unit to perform particular tasks or implement particular abstract data types. This system may be practiced in distributed computing environments where tasks are performed by remote processing devices that are linked through a communications network. In a distributed computing environment, program modules may be located in both local and remote computer storage media including memory storage devices.

The terms “article of manufacture”, “process”, “machine” and “composition of matter” in the preambles of the appended claims are intended to limit the claims to subject matter deemed to fall within the scope of patentable subject matter defined by the use of these terms in 35 U.S.C. §101.

Any or all of the aforementioned alternate embodiments described herein may be used in any combination desired to form additional hybrid embodiments. It should be understood that the subject matter defined in the appended claims is not necessarily limited to the specific implementations described above. The specific implementations described above are disclosed as examples only.

What is claimed is:

1. A computer-implemented process comprising:
receiving into memory commercial communications from one or more channels;
extracting and storing information about the commercial communications;
presenting one or more views of aggregated information about the commercial communications to a user; and
enabling the user to interact with the aggregated information about the commercial communications.

2. The computer-implemented process of claim 1, further comprising filtering commercial communications from noncommercial communications from at least one of the one or more channels.

3. The computer-implemented process of claim 1, wherein the one or more views includes a calendar view of multiple commercial communications.

4. The computer-implemented process of claim 1, wherein the one or more views includes a map view illustrating a location of a source related to one or more multiple commercial communications.

5. The computer-implemented process of claim 1, wherein one of the channels includes electronic mail and another of the channels includes advertisements from an advertisement server.

6. The computer-implemented process of claim 5, wherein information about advertisements is stored persistently for a user.

7. The computer-implemented process of claim 6, further comprising receiving input from a user for rating commercial communications and storing such rating information with the information about the commercial communications.

8. The computer-implemented process of claim 1, wherein a view of the commercial communications includes grouping and displaying messages by sender.

9. The computer-implemented process of claim 1, wherein a view of the commercial communications includes grouping and displaying messages by subject matter.

10. The computer-implemented process of claim 1, wherein a view of the commercial communications includes grouping and displaying messages by keyword.

11. An article of manufacture comprising:
a computer storage medium;
computer program instructions stored on the computer storage medium which, when processed by a processing device, instruct the processing device to perform a process comprising:
receiving into memory commercial communications from one or more channels;
extracting and storing information about the commercial communications;
presenting one or more views of aggregated information about the commercial communications to a user; and
enabling the user to interact with the aggregated information about the commercial communications.

12. The article of manufacture of claim 11, further comprising filtering commercial communications from noncommercial communications from at least one of the one or more channels.

13. The article of manufacture of claim 11, wherein the one or more views includes a calendar view of multiple commercial communications.

14. The article of manufacture of claim 11, wherein the one or more views includes a map view illustrating a location of a source related to one or more multiple commercial communications.

15. The article of manufacture of claim 11, wherein one of the channels includes electronic mail and another of the channels includes advertisements from an advertisement server.

16. The article of manufacture of claim 15, wherein information about advertisements is stored persistently for a user.

17. The article of manufacture of claim 16, further comprising receiving input from a user for rating commercial communications and storing such rating information with the information about the commercial communications.

18. The article of manufacture of claim 11, wherein a view of the commercial communications includes grouping and displaying messages by sender.

19. The article of manufacture of claim 11, wherein a view of the commercial communications includes grouping and displaying messages by subject matter.

20. The article of manufacture of claim 11, wherein a view of the commercial communications includes grouping and displaying messages by keyword.
